(19) United States
(12) Patent Application Publication
(10) Pub. No.: US 2026/0214300 A1
(43) Pub. Date: Jul. 23, 2026

(54) System and Method for Real-Time AI-Driven Adaptive Multimedia Personalization

(71) Applicant: Dean Bowes, Mableton, GA (US)

(72) Inventor: Dean Bowes, Mableton, GA (US)

(21) Appl. No.: 19/466,468

(22) Filed: Feb. 1, 2026

(51) Int. Cl. H04N 21/472; H04N 21/414; H04N 21/4402; H04N 21/4415; H04N 21/466

(52) U.S. Cl. CPC H04N 21/47205; H04N 21/41407; H04N 21/44029; H04N 21/4415; H04N 21/466

(57) ABSTRACT

This invention provides a system and method for real-time, AI-driven personalization of multimedia content for both home and theater environments. The system integrates AI modules to dynamically adapt casting, dialogue, visual, and audio elements based on user preferences, cultural settings, and perspective selections. In public theaters, personalization is enabled through wearable devices with biometric authentication, ensuring secure, user-specific experiences, while home users access full customization directly via playback devices. The system incorporates blockchain-based security to prevent unauthorized access and contains dormant avatar integration technology, allowing future replacement or augmentation of actors with AI-generated user representations. The invention is media-agnostic, applicable to both visual and audio content, and enables seamless transitions between traditional and personalized content, providing a flexible framework for adaptive entertainment without disrupting existing production or distribution models.

### DEFINITIONS

### 1 Adaptive Multimedia Content

Content that can be altered in real-time to reflect user preferences, including actors, dialogue, visuals, audio, and cultural or perspective-based adjustments, without changing the underlying narrative structure or plot.

### 2 AI Module

The software component configured to dynamically select and substitute pre-recorded media elements (actors, dialogue, visual framing, audio cues) in real-time based on user preferences or profiles, while maintaining seamless audiovisual continuity.

### 3 .aiMovie Container

A media container comprising multiple pre-recorded variations of a single film, where each variation may include different actors, dialogue delivery, or culturally sensitive adaptations, but all share identical plot, scenes, and story continuity. The AI module operates on this container to render the viewer-selected version.

### 4 Pre-Recorded Performance

A recorded set of audiovisual elements corresponding to a particular actor performing a specific role, including voice, gestures, expressions, and visual framing. Multiple pre-recorded performances for the same character are used to enable real-time actor substitution.

### 5 Wearable Device Interface

A hardware and software interface, including glasses, headphones, or other wearable devices, used in public theaters to provide biometric authentication, synchronize user-specific preferences, and enable secure adaptive content playback.

### 6 Dormant Avatar Integration Module

A built-in, inactive technology embedded in the system, designed to allow future substitution or augmentation of actors with AI-generated user avatars in both audio and visual media. Activation occurs via a future software update.

### 7 Seamless Audiovisual Mapping

A process whereby substituted content elements (actors, dialogue, visuals, audio) are synchronized to existing media frames and timelines to prevent disruption of visual or audio continuity during playback.

### 8 Cultural and Perspective Settings

Adjustments applied to content to align with regional, cultural, or personal sensitivities and viewer preferences, including language localization, visual framing, or audio nuances.

### 9 Blockchain-Based Authentication

A privacy-preserving mechanism using blockchain technology, digital tokens, and/or zero-knowledge proofs to verify user identity, ownership of wearable devices, and secure access to personalized media content.

### 10 Home Viewing Experience

A private setting in which users access the full adaptive multimedia features via personal devices, such as smart TVs or streaming platforms, without requiring wearable devices.

### FIELD OF INVENTION

The present invention relates to digital home entertainment and movie theater systems, specifically systems that dynamically alter media content in real-time based on viewer preferences, cultural backgrounds, and personal tastes, with or without the need for wearable devices.

### BACKGROUND

Traditional cinematic experiences do not account for the varied cultural and personal backgrounds of a diverse audience, often leading to a one-size-fits-all approach. There exists a need for a system that allows viewers to personalize and adapt their movie experience while still maintaining alignment with the existing Hollywood production and distribution model. The Cinematic Choice Platform (CCP) provides a structured pathway into the future of AI-enhanced cinema while preserving the integrity of traditional filmmaking.

### SUMMARY OF THE INVENTION

The invention provides a system and method for dynamically adapting media content in real time for both home cinema and movie theater experiences, with or without the need for wearable devices. Unlike previous implementations that require specialized wearables such as glasses or headphones, this system functions entirely through AI-driven software integrated into streaming platforms, smart TVs, movie theater projection systems, and other digital media playback devices. Additionally, the system contains built-in technology that, at a later stage, will allow users to insert their own AI-generated avatars into the content—though this feature will not be available at initial launch. The platform follows the traditional Hollywood filmmaking and distribution model, ensuring alignment with existing industry standards. However, it has the future capability to introduce fully personalized avatar-based experiences, which will be activated at a later phase, giving audiences a seamless transition into the next evolution of cinema.

The AI module operates on a pre-bundled set of alternative actor performances, maintaining identical plot, scenes, and narrative structure. The module enables real-time substitution of actors, dialogue, visual framing, and audio cues based on viewer preferences, without altering story continuity.

### DETAILED DESCRIPTION

### Ticket Booth Selection & Viewing Experience Customization

The Cinematic Choice Platform (CCP) offers flexibility in how audiences experience movies, both in public theaters and home settings. Viewers can select their preferred experience at the ticket booth or via a streaming platform, ensuring a tailored and immersive cinematic experience.

### Movie Theater Experience (public Setting—Requires Personal Ownership of Glasses & Headphones or Selection of a Single-Actor Screening)

Glasses & Headphones are NOT provided by the theater. Viewers must already own CCP-compatible glasses and headphones to access the personalized experience. This ensures that each device remains uniquely tied to its owner via biometric authentication and avatar security measures.
At the ticket booth, consumers choose a type of ticket that determines their initial movie settings:
CCP-Compatible Experience: Viewers with CCP glasses and headphones can enter a fully adaptive screening room, where they can dynamically change actors, audio, and other settings.
Non-CCP Experience (Single-Actor Viewing): Viewers without CCP-compatible wearables can select a dedicated screening room for a single-actor version of the film.
Room A: Brad Pitt ONLY
Room B: Denzel Washington ONLY
Room C: John Leguizamo ONLY
This ensures that all customers have a choice, whether they want a traditional, single-cast movie experience or a fully dynamic version using CCP technology.

Seamless Viewing Experience: Users with compatible devices can adjust their settings during the film, switching actors or perspectives without disrupting the experience for others, while non-CCP users enjoy a traditional screening experience in their chosen room.

### Home Viewing Experience (no Wearables Required)

In a private setting, such as home theaters or streaming services, CCP allows viewers to experience content without the need for additional hardware.
Since home viewers have more control over their environment, content customization can be fully integrated into the streaming platform, smart TV, or personal devices without requiring glasses or headphones.
Users can change actor selections, adjust cultural settings, or even enable AI-generated avatars in real-time, making the home experience more flexible and immersive.

### Key Distinction Between Theater & Home Use

Theater Setting (Public)→Requires the user to own CCP-compatible glasses & headphones for fully dynamic content, OR they can select a single-actor version in a dedicated screening room.

Home Setting (Private)→No Wearables Required for full AI-driven customization directly on the viewing device.

By implementing this system, CCP ensures that audiences in both theaters and home settings can enjoy a personalized cinematic experience without disrupting traditional Hollywood distribution models. The theater setup maintains industry standards while offering a gateway to the future of adaptive storytelling and AI-driven cinema.

The Cinematic Choice Platform (CCP) offers flexibility in how audiences experience movies, both in public theaters and home settings. Viewers can select their preferred experience at the ticket booth or via a streaming platform, ensuring a tailored and immersive cinematic experience.

### Movie Theater Experience (public Setting—Requires Personal Ownership of Glasses & Headphones)

Glasses & Headphones are NOT provided by the theater. Viewers must already own CCP-compatible glasses and headphones to access the personalized experience. This ensures that each device remains uniquely tied to its owner via biometric authentication and avatar security measures.
At the ticket booth, consumers choose a type of ticket that determines their initial movie settings (e.g., preferred actor selection, language, and cultural adjustments).
CCP-Compatible Viewing Rooms: Movie theaters will have dedicated screening rooms where only those with CCP-compatible glasses and headphones can experience dynamic film adaptation.
If a viewer does not own CCP-compatible wearables, they may choose to watch the standard, non-adaptive version of the movie in a traditional single-sided screening room.
Seamless Viewing Experience: Users with compatible devices can adjust their settings during the film, switching actors or perspectives without disrupting the experience for others.

### Dynamic Actor Selection & Multi-Variant Casting

One of the key features of the Cinematic Choice Platform (CCP) is the ability to dynamically alter the cast within a film, allowing the viewer to choose between different actors for the same role. Instead of a single lead performer, multiple actors—such as Brad Pitt, Denzel Washington, and John Leguizamo—are all filmed for the same role, ensuring that viewers can select the version that resonates most with them.
Hollywood Employment Model: Each of these actors is fully employed in the film, meaning that every actor performs the same scenes, delivering their own unique interpretation of the role.
User Choice in Theaters & Home Viewing: Before the movie begins, the viewer can select which actor they prefer for a given role. This selection is stored and applied dynamically in real time using AI-driven content adaptation.
Seamless Actor Switching: Users are not locked into their initial choice; they can change actors mid-movie to experience different performances and perspectives dynamically.
Same Film, Different Perspectives: Since each actor brings their own artistic interpretation, audiences can see how different casting choices affect tone, dialogue delivery, and emotional depth, enhancing their engagement with the story. This feature ensures that multiple actors are hired per role, maintaining alignment with Hollywood's existing employment and casting practices while introducing a revolutionary level of personalization to cinema experiences.

### Future Avatar Integration Capability

The system contains dormant technology that will allow for AI-generated user avatars to be placed inside films at a later date. This feature will remain inactive initially but is embedded into the architecture of the device. The transition will be introduced through a future software update, allowing audiences to experience fully personalized cinema when the industry is ready for full integration.

### Industry Context and Prior Art

Recent efforts in personalized media, such as the 2028 Beatles productions, demonstrate the growing demand for multi-perspective or multi-actor experiences. However, these implementations rely on fully pre-produced, single-version releases or heavily rely on specialized AI systems for content adaptation that are not widely integrated into traditional movie production workflows. CCP distinguishes itself by providing a hybrid model: it operates primarily on fully pre-shot, traditional films, preserving standard Hollywood production and distribution processes, while enabling optional real-time AI adaptation, including actor switching, cultural adjustments, and future avatar integration. This dual-mode approach allows CCP to deliver a production-ready system today, while simultaneously preparing for the future of .aiMovie personalization.

### CONCLUSION

The present invention provides a comprehensive system and method for real-time, AI-driven adaptive multimedia personalization, applicable to both visual and audio media. By integrating pre-recorded alternative performances, AI-driven substitution, seamless audiovisual mapping, and optional wearable authentication, the system delivers fully personalized cinematic and musical experiences while preserving narrative continuity and production integrity.

The Cinematic Choice Platform (CCP) addresses a critical gap in traditional entertainment systems by enabling dynamic customization of actors, dialogue, visuals, and audio based on user preferences, cultural context, and perspective, without altering the underlying story. Additionally, the dormant avatar integration module and blockchain-based security mechanisms provide a forward-looking framework for secure, immersive, and fully personalized experiences in both public and private viewing environments.

This invention represents a novel and non-obvious improvement over existing entertainment delivery systems, offering a flexible, media-agnostic solution that enhances audience engagement, respects creative rights, and preserves the structure of traditional film and audio production. It provides a robust foundation for the future of AI-enhanced adaptive content while remaining fully compatible with current industry standards and distribution models.

### ADDENDUM: APPLICATION TO AUDIO MEDIA

It is understood that the systems, methods, modules, and processes described in the present patent, while primarily illustrated with visual media such as films, are equally applicable to audio-only media, including songs, musical performances, spoken word, or other vocal content (hereinafter “.AIMusic”).

Personalized avatar integration, real-time mapping, AI-driven autonomous generation, biometric authentication, and secure blockchain/zero-knowledge proof validation described herein can be applied to user vocal avatars, enabling real-time substitution, augmentation, or integration of a user's voice into original audio content.

The proprietary file format and all methods of preserving original content integrity, mapping avatars, and synchronizing expressive features extend seamlessly to audio media using the .AIMusic format, without modification of the underlying invention.

This addendum clarifies that the patent's teachings are media-agnostic, covering both visual and audio embodiments, while maintaining all original claims, security, and AI-driven workflows.

1. A system for real-time adaptive multimedia content personalization, comprising:
a. a content playback engine integrated with digital media platforms, including smart TVs, streaming services, and movie theater projectors, configured to render audio and visual media;
b. an artificial intelligence module configured to dynamically select and substitute content elements, including actors, dialogue, visuals, and audio, in real-time based on user input and preference profiles;
c. a user interface enabling selection of actors, cultural settings, language preferences, and perspective filters; and
d. an optional wearable device interface for use in public theaters, configured to synchronize user-specific preferences via biometric authentication and secure token exchange.

2. The system of claim 1, wherein the AI module selects among multiple pre-recorded performances for a single character role, applying seamless audiovisual mapping to maintain continuity.

3. The system of claim 1, wherein the AI module dynamically switches actors or perspectives during playback without disrupting synchronization of audiovisual content.

4. The system of claim 1, wherein personalized adaptation in public theaters is enabled only for users authenticated via the wearable device interface.

5. The system of claim 1, further comprising a privacy-preserving authentication mechanism using blockchain and biometric verification to prevent unauthorized access to personalized content.

6. The system of claim 1, further comprising a dormant avatar integration module embedded for future activation, configured to replace or augment actors with AI-generated user representations, applicable to both audio and visual media.

7. A method for providing adaptive multimedia experiences, comprising:
a. receiving user input to select actor, language, cultural, and perspective preferences at the point of content launch or ticket purchase;
b. dynamically rendering media content using an artificial intelligence module in accordance with the selected preferences; and
c. switching between traditional content and AI-personalized content based on user authentication and wearable device ownership.

8. The method of claim 7, wherein actor substitution is executed by mapping pre-recorded visual and audio data of alternate actors into original content frames using a data library, ensuring seamless audiovisual continuity.

9. The method of claim 7, wherein home users access full content customization features without requiring wearable devices.

10. A non-transitory machine-readable medium encoded with instructions that, when executed by a processor, cause the system to:
a. receive user customization preferences;
b. render multimedia content adapted to the received preferences; and
c. provide seamless transitions between user-selected options during playback, including substitution of actors, dialogue, visuals, and audio.
